(19) United States
(12) Patent Application Publication
(10) Pub. No.: US 2025/0045590 A1
(43) Pub. Date: Feb. 6, 2025

(54) ARCHITECTURE AND OPERATION OF INTELLIGENT SYSTEM

(71) Applicant: Numenta, Inc., Redwood City, CA (US)

(72) Inventors: Jeffrey C. Hawkins, Atherton, CA (US); Subutai Ahmad, Palo Alto, CA (US); Viviane Clay, Mommenheim (DE); Niels Leadholm, Oxford (GB)

(21) Appl. No.: 18/751,199

(22) Filed: Jun. 22, 2024

Related U.S. Application Data
(60) Provisional application No. 63/593,998, filed on Oct. 29, 2023.
(60) Provisional application No. 63/516,845, filed on Jul. 31, 2023.

(51) Int. Cl. G06N 3/088

(52) U.S. Cl. CPC G06N 3/088

(57) ABSTRACT

Embodiments relate to an intelligent system that recognizes an object and its state, or affect changes in the state of the object to a target state, based on sensory input. The intelligent system includes sensor processors and learning processors. The sensor processors receives the sensory input from sensors and determines features in the sensory input. The sensor processors also receive poses of the sensors expressed in coordinate systems local to the sensors and converts them into poses expressed in a common coordinate system. Learning processors initialize an evidence value for each hypothesis on a corresponding model, its pose and/or its state, and update the evidence value as additional features are detected or additional signals are received. If none of the hypotheses has an evidence value above a threshold, it is determined that no matching model is found, and hence, a new model is generated and stored in the learning processor.

### CROSS-REFERENCE TO RELATED APPLICATIONS

This application claims priority under 35 U.S.C. § 119 (e) to U.S. Provisional Patent Application No. 63/516,845, filed on Jul. 31, 2023, and U.S. Provisional Patent Application No. 63/593,998, filed on Oct. 29, 2023, which are incorporated by reference herein in their entirety.

### BACKGROUND

### 1. Field of the Disclosure

The present disclosure relates to an intelligent system for performing inference, predictions, interacting with the environment or creating content.

### 2. Description of the Related Arts

Intelligent systems have a variety of applications including object detection. Object detection systems aim to find or recognize different types of objects present in input data. The input data for object detection may be in the form of image data, video data, tactile data, or other types of sensor data. For example, an object detection system may recognize different objects, such as a coffee cup, a door, and the like, included in visual images that are captured by a camera or sensed by tactile sensors.

Conventional object detection systems face many challenges. One of such challenges is that the same object may be placed in different locations and/or orientations. The change in the locations and/or orientations of the objects from the originally learned locations and/or orientations may cause the conventional object detection systems to recognize the same object as different objects. Existing object detection models, such as convolutional neural network models (CNN), are not always sufficient to address the changes in the locations and/or orientations, and often require significant amounts of training data even if they do address such changes.

Moreover, regardless of the types of sensors, the input data including a representation of an object has spatial features that would distinguish it from a representation of another object. The absence of spatially distinctive features may give rise to ambiguity as to the object being recognized. Conventional object detection systems do not adequately address such ambiguity in the objects being recognized.

### SUMMARY

Embodiments relate to an intelligent system that includes learning processors and sensor processors. The sensor processors process sensory input to identify one or more features and convert the raw poses represented in local coordinate systems into poses represented in a common coordinate system. The one or more identified features and the converted poses are sent to the learning processors. Each of the learning processors stores its models of objects. In response to receiving the features and the poses, each of the learning processors compares them with the models it stores. Each of the learning processors may store its own set of models. The learning processors generate an output as its prediction, inference or creation based on the comparison of the features and the poses of the current model with the models. If a learning processor finds no matching model, the learning processor may generate a new model corresponding to the features and the poses.

### BRIEF DESCRIPTION OF THE DRAWINGS

The teachings of the embodiments can be readily understood by considering the following detailed description in conjunction with the accompanying drawings.

Figure (FIG. 1 is a conceptual diagram of an intelligent system, according to one embodiment.

FIG. 2 is a block diagram illustrating components of the intelligent system, according to one embodiment.

FIG. 3A is a block diagram illustrating signals communicated between components of the intelligent system, according to one embodiment.

FIG. 3B is a block diagram illustrating reflex signals sent from sensor processors to motor controllers, according to one embodiment.

FIG. 4 is a conceptual diagram illustrating agents associated with sensors, according to one embodiment.

FIG. 5 is a block diagram illustrating a sensor processor in the intelligent system, according to one embodiment.

FIG. 6 is a block diagram illustrating a learning processor in the intelligent system, according to one embodiment.

FIG. 7A is a block diagram illustrating a model builder in the learning processor, according to one embodiment.

FIG. 7B is a block diagram illustrating an inference generator in the learning processor, according to one embodiment.

FIG. 8 is a flowchart illustrating processes in the intelligent system, according to one embodiment.

FIGS. 9A and 9B are flowcharts illustrating a process of generating or updating models in the learning processor, according to one embodiment.

FIG. 10 is a conceptual diagram illustrating a graph model of a mug, according to one embodiment.

FIGS. 11A and 11B are flowcharts illustrating operations performed by an inference generator of the learning processor, according to one embodiment.

FIG. 12A is a diagram illustrating a model of an object with discretized feature points, according to one embodiment.

FIG. 12B is a diagram illustrating levels of evidence values for different discretized feature points, according to one embodiment.

FIGS. 13A and 13B are conceptual diagrams illustrating identifying of matching points, according to one embodiment.

FIG. 14 is a conceptual diagram illustrating the operations of the learning processor at different episode cycles, according to one embodiment.

FIG. 15 is a block diagram of a computing device for implementing intelligent systems, according to embodiments.

### DETAILED DESCRIPTION OF EMBODIMENTS

In the following description of embodiments, numerous specific details are set forth to provide more thorough understanding. However, note that the present invention may be practiced without one or more of these specific details. In other instances, well-known features have not been described in detail to avoid unnecessarily complicating the description.

Certain aspects of the embodiments include process steps and instructions described herein in the form of an algorithm. It should be noted that the process steps and instructions of the embodiments could be embodied in software, firmware or hardware, and when embodied in software, could be downloaded to reside on and be operated from different platforms used by a variety of operating systems.

Embodiments also relate to an apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The language used in the specification has been principally selected for readability and instructional purposes, and may not have been selected to delineate or circumscribe the inventive subject matter. Accordingly, the disclosure set forth herein is intended to be illustrative, but not limiting, of the scope.

Embodiments relate to an intelligent system that recognizes an object and its state, or affects changes in the state of the object to a target state, based on sensory input. The intelligent system includes sensor processors and learning processors. The sensor processors receive the sensory input from sensors and determine features in the sensory input. The sensor processors also receive poses of objects or poses of their parts expressed in coordinate systems local to the sensors and convert them into poses expressed in a common coordinate system. The learning processors initialize an evidence value for each hypothesis on a corresponding model, its pose and/or its state, and update the evidence value as additional features are detected or additional signals are received. The learning processors may also generate and store new models of the objects.

An object described herein refers to a tangible physical entity, an abstract construct, or a virtual representation thereof. The object has stable and persistent characteristics and properties that enable it to be perceived as the same entity, construct, or representation despite the elapse of time or changes in its state. The object may include tangible physical entities (e.g., a table and a chair) that can be physically interacted with, as well as representations or constructs that are conceptual in nature (e.g., democracy and constitutional rights) without a physical counterpart. Additionally, the object may include multiple parts or aspects. The “parts” of an object are used herein as being interchangeable with the “aspects” of the object.

A location described herein refers to a coordinate of an object or a part of the object relative to a common coordinate system. The common coordinate system may be set relative to the body of a robotic system that includes sensors. Each sensor may have its local coordinate system that may be converted into the common coordinate system.

A feature of an object described herein refers to a property associated with a part of the object or the entire object. The same feature may be shared across multiple objects or parts of the same object. The features of an object may include, among others, shapes (e.g., a flat surface or a sharp edge), colors, textures (e.g., smooth or rough), materials, sizes, weights, patterns, transparency and functionalities (e.g., presence of moveable parts).

A state of an object described herein refers to a characteristic of the object. The state may include the location and the orientation of the object. The state may include, among others, a location and an orientation of the object and a mode if the object may be placed in one or more of different modes (e.g., a stapler as an object that may be in a closed mode or an open mode). The state may also include other characteristics of the object such as velocity, pressure, dimensions, weight, traffic congestion state, operating status and health status.

### High-Level Overview of Intelligent System

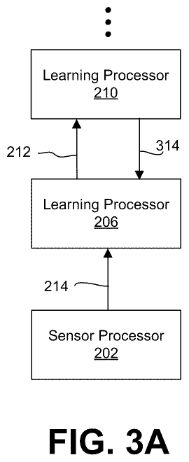

FIG. 1 is a conceptual diagram of an intelligent system 106, according to one embodiment. Intelligent system 106 performs inference based on sensory input data 110 received from one or more sensors 104A through 104Z (collectively hereinafter referred to as “sensors 104” or individually as “sensor 104”) that move along with associated agents, which makes relative movement against object 102. The movement of the agents may be caused by one or more actuators 222 that operate by control signals 246 generated by intelligent system 106. The sensors 104 may be moved individually or collectively as a set, as described below in detail with reference to FIG. 4.

Intelligent system 106 may perform operations associated with inference, prediction and/or creation based on objects, and generate inference output data 130. For example, intelligent system 106 may receive sensory input data 110 corresponding to sensors at different locations on object 102, and perform object recognition based on the received sensory input data 110. As another example, intelligent system 106 may predict sensory input data 110 at a particular part of object 102. Inference output data 130 indicates the result of inference, prediction on identity or construction of object 102 or objects, or generation of content (e.g., images, texts, videos or sounds), as performed by the intelligent system 106. As a further example, the intelligent system 106 may generate content such as images, texts, sounds or videos as the result based on the sensory input data 110 representing one or more of texts, videos, images and sounds or any other types of information.

Although embodiments are described below primarily with respect to recognizing an object and/or its state based on the sensory input data 110, intelligent system 106 may be used in other applications using different types of sensory input data. For example, intelligent system 106 may receive sensory input data from online probes that navigate and measure traffic in different parts of a network, and determine whether the network is in a congested or anomalous state, predict or estimate the performance of financial instruments, determine whether communication signals are benign or malign, authenticate a person or entity, determine states of machines or processes, diagnose ailments of patients, detect pedestrian or objects for autonomous vehicle navigation, control a robot to manipulate objects in its environment, and generate contents such as texts, images, sounds and videos.

The sensory input data 110 may include, among others, images, videos, audio signals, sensory signals (e.g., tactile sensory signals), data related to network traffic, financial transaction data, communication signals (e.g., emails, text messages and instant messages), documents, insurance records, biometric information, parameters for manufacturing process (e.g., semiconductor fabrication parameters), inventory patterns, energy or power usage patterns, data representing genes, results of scientific experiments or parameters associated with operation of a machine (e.g., vehicle operation), medical treatment data, content such as texts, images sounds or videos, and locations of a subunit of content (e.g., token, pixels, frame) within the contents. The underlying representation (e.g., photo and audio) can be stored in a non-transitory storage medium. In the following, the embodiments are described primarily with reference to a set of tactile sensors on a robotic hand or an image sensor, merely to facilitate explanation and understanding of intelligent system 106.

Features detected by processing sensor input data 110 may include, among others, the geometry of a shape, texture, curvature, color, brightness, semantic content, intensity, chemical properties, and abstract values such as network traffic, stock prices, or dates.

Intelligent system 106 may process sensory input data 110 to produce output data 130 representing, among others, identification of objects, identification of recognized gestures, classification of digital images as pornographic or non-pornographic, identification of email messages as unsolicited bulk email (“spam”) or legitimate email (“non-spam”), identification of a speaker in an audio recording, classification of loan applicants as good or bad credit risks, identification of network traffic as malicious or benign, identity of a person appearing in the image, natural language processing, weather forecast results, patterns of a person's behavior, control signals for machines (e.g., automatic vehicle navigation), gene expression and protein interactions, analytic information on access to resources on a network, parameters for optimizing a manufacturing process, identification of anomalous patterns in insurance records, prediction on results of experiments, indication of illness that a person is likely to experience, selection of contents that may be of interest to a user, indication on prediction of a person's behavior (e.g., ticket purchase, no-show behavior), prediction on election, prediction/detection of adverse events, a string of texts in the image, indication representing topic in text, a summary of text or prediction on reaction to medical treatments, content such as text, images, videos, sound or information of other modality, and control signals for operating actuators (e.g., motors) to achieve certain objectives. In the following, the embodiments are described primarily with reference to the intelligent system that recognizes objects to facilitate explanation and understanding.

### Example Architecture of Intelligent System

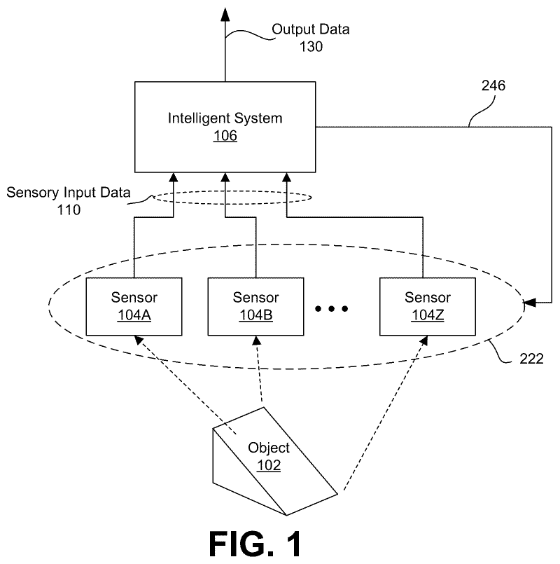

FIG. 2 is a block diagram illustrating components of intelligent system 106, according to one embodiment. Intelligent system 106 in FIG. 2 is an example of a hierarchically structured system that includes components such as sensor processors 202A through 202M (collectively referred to hereinafter as “sensor processors 202” and individually also as “sensor processor 202”), lower-level learning processors 206A through 206N (collectively referred to hereinafter as “learning processors 206” or individually as “learning processor 206”), a higher-level learning processors 210A through 2100 (collectively referred to hereinafter as “learning processors 210” and individually as “learning processor 210”), motor controllers 204A, 204B (collectively referred to hereinafter as “motor controllers 204” and individually as “motor controller 204”), and an output processor 230.

Sensors 104 generate sensory input data 110 that is provided to intelligent system 106. Sensory input data 110 indicates one or more physical properties at a part of an object or an entire object. Sensors 104 may be of different modalities. For example, sensors 104A, 104B may be of a first modality (e.g., tactile sensing) while sensor 104Z may be of a second modality (e.g., image sensing). Intelligent system 106 is capable of processing sensory input data 110 generated by sensors 104 of different modalities. Although only two modalities of sensors are illustrated in FIG. 2, sensors of many more modalities may provide sensory input data 110 to intelligent system 106.

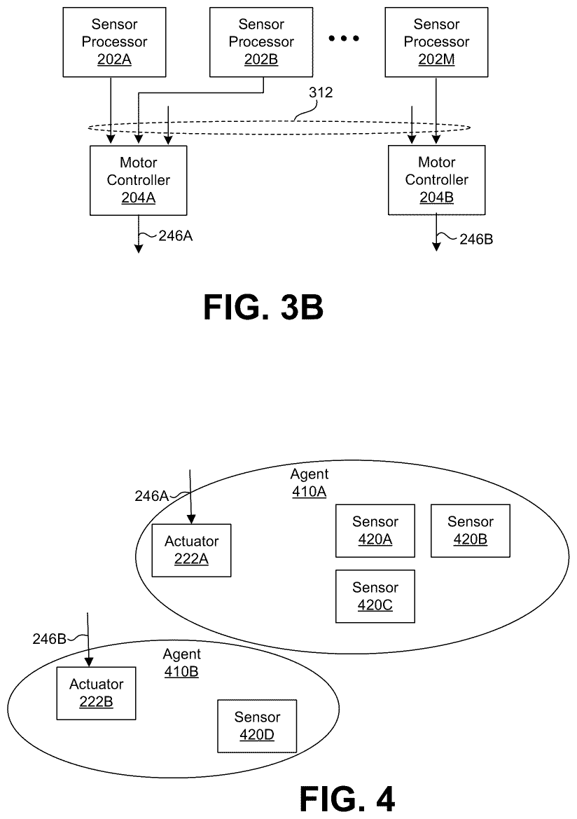

Sensor processors 202 are hardware, software, firmware or a combination thereof for generating sensor signals 214A through 214M (hereinafter collectively referred to as “sensor signals 214” or also individually as “sensor signal 214”) for performing inference, prediction or content generation operations at intelligent system 106. Specifically, each of sensor processors 202 processes sensory input data 110A through 110Z (collectively corresponding to sensor input data 110 of FIG. 1) or a subset thereof and generates corresponding sensor signal 214, as described below in detail with reference to FIG. 5. Although not illustrated in FIG. 2, some of the sensor processors 202 may receive the same sensory input data 110 from the same sensor 104. Different sensor processors 202 may extract and process different aspects of the same sensory input data 110, and generate different sensor signals 214.

Learning processors 206, 210 are hardware, software, firmware or a combination thereof that makes prediction/inference on the object or create content, according to various information they receive. Information used by a learning processor may include, among others, sensor signal 214 from sensor processor 202 or inference output 212 received from another learning processor at a lower level, and lateral vote signal 224, 228 received from other learning processors at the same level or different levels. Alternatively or in addition, a learning processor may use downstream signals from other learning processors at a higher level in the hierarchy to perform its operations.

Although FIG. 2 shows sensor signals 214 being fed only to lower-level learning processors 206, in other embodiments, sensor signals 214 may be provided also to higher-level processors 210 and/or output processor 230. Further, all or a subset of inference outputs 212 from lower-level learning processor 206 may also be provided to the output processor 230.

In one or more embodiments, each of the learning processors develops its models of objects during its learning phase. Such learning may be performed in an unsupervised manner or in a supervised manner based on information that each of the learning processors has accumulated. The models developed by each of the learning processors may differ due to the differences in sensor signals 214 that each learning processor has received for learning and/or parameters associated with its algorithms. Different learning processors may retain different models of objects but share their inference, prediction or created content with other learning processors in the form of inference output 212 and/or lateral vote signal 224, 228.

By sharing lateral vote signals 224, 228 among the learning processors 206, 210 at the same level, more robust and faster inferencing may be performed by intelligent system 106. A lateral vote signal from a learning processor (e.g., learning processor 206A) indicates the likely poses (or candidate poses, e.g., locations and orientations), likely (or candidate) identities of object and/or likely (or candidate) state of an object associated with the sensory input, as inferred or predicted by the learning processor. Another learning processor (e.g., learning processor 206B) receiving the lateral vote signal may consider the lateral vote signal from the sending learning processor (e.g., 206A) and update its inference or prediction of the likely poses, likely identities of objects, or likely state of an object. In other embodiments, the lateral vote signals may be sent between learning processors at different levels.

Learning processors may be organized into a flat architecture or into a multi-layered architecture. FIG. 2 illustrates a hierarchical architecture where learning processors 206 are at a lower level and learning processors 210 are at a higher level. Learning processors 206 receive sensor signal 214 from sensor processor 202, while learning processors 210 receive inference output 212 from learning processors 206 at a lower level. Because inference output 212 tends to remain constant over a longer time, learning processors 210 at a higher level generate inference outputs 238 that are more time invariant and stable relative to inference outputs 212 generated by learning processors 206 at a lower level. Moreover, in scenarios where each of learning processors 210 receives inference output 212 from multiple learning processors 206, inference output 238 generated by learning processors 210 represents more abstract or higher-level information of an object/objects or a larger context associated with the object/objects than inference outputs 212.

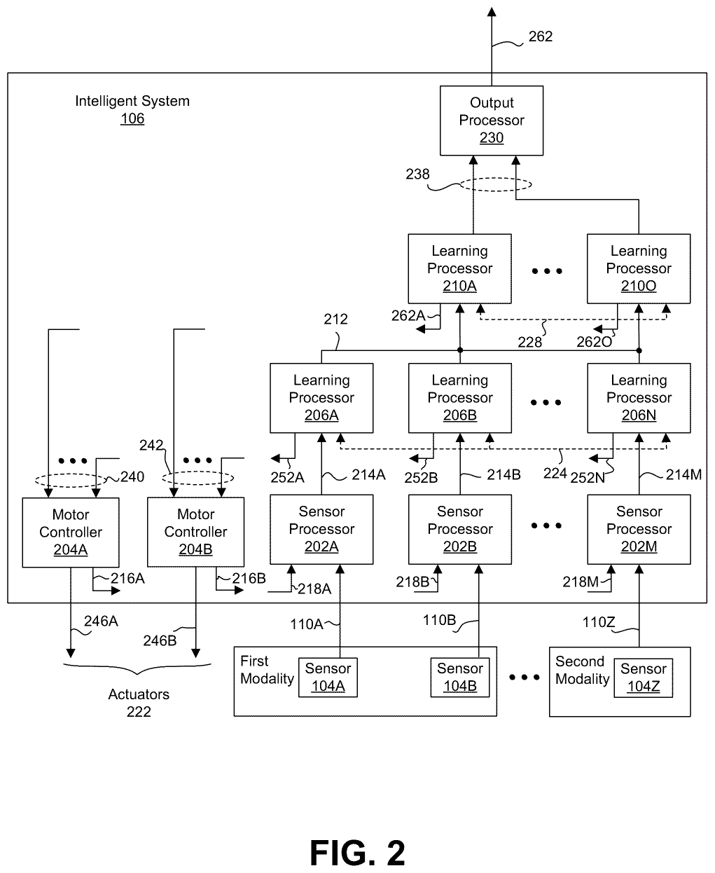

As shown in FIG. 3A, learning processors 210 at a higher hierarchical level may send downstream signal 314 to learning processor 206 at a lower hierarchical level. Downstream signal 314 may be a version of inference output generated at learning processors 210 and may indicate a higher-level information or a larger context relative to output 212 from learning processor 206. For example, downstream signal 314 may indicate a higher-level object (e.g., a car) whereas inference output 212 may indicate a lower-level object (e.g., a wheel) that is part of the higher-level object.

Output processor 230 is hardware, software, firmware or a combination thereof that receives inference output 238 and generates system output 262 indicating the overall inference, prediction or content generation produced by intelligent system 106. System output 262 may correspond to inference output data 130 of FIG. 1. System output 262 may indicate the highest likely object/objects (e.g., candidate object/objects), their poses and/or their states, as inferred, predicted by intelligent system 106. Alternatively, system output 262 may indicate various likely object/objects, their poses and/or their states along with their confidence values. In other embodiments, output processor 230 may merely concatenate inference output 238 from different learning processors 210 into system output 262. The inference output 238 may also include information from other learning processors such as inference outputs 212 from learning processors 206 or sensor signals 214 from sensor processors 202. In yet other embodiments, output processor 230 may be omitted, and control signals from motor controllers 204 may be provided as an output of intelligent system 106.

FIG. 3B is a block diagram illustrating reflex signals 312 sent from sensor processors 202 to motor controllers 204A, 204B, according to one embodiment. Reflex signals 312 are generated to take prompt actions at motor controllers 204A, 204B without the intervention of learning processors. Reflex signals 312 are generated, for example, to avoid sudden failure or damage to actuators or sensors.

The structure and organization of components in FIG. 2 are merely illustrative, and these components may be organized into various architectures, and other functional processors or controllers may also be employed. In other embodiments, additional signals may be communicated between the components of the intelligent system.

### Example Actuator Control

Motor controllers 204A, 204B are hardware, software, firmware or a combination thereof for generating control signals 246A, 246B (collectively referred to hereinafter as “control signals 246”) to operate actuators 222A, 222B (collectively referred to as “actuators 222”). Motor controllers 204A, 204B may be embodied, for example, as a Proportional-Integral-Derivative (PID) controller that continuously monitors the differences between target states of one or more actuators and measured states of the one or more actuators, and applies corrections to reduce such differences. Other types of controllers such as fuzzy logic control, model predictive controller (MPC) or state space controller may also be used as motor controllers 204A, 204B.

Motor controllers 204 receive control inputs 240, 242, each of which corresponds to all or a subset of target states 252A through 252M and 264A through 2640 generated by learning processors 206, 210. A target state from a learning processor may indicate a target pose of actuators 222 or sensors 104. The target pose may be a pose that is likely to produce sensory input data 110 that resolves ambiguity or increases the accuracy of the inference, prediction or creation made by the learning processor. Alternatively, the target pose may be a pose that indicates how the actuators should be operated to manipulate the environment in a desired manner. The target pose may be translated into individual motor commands for operating individual actuators 222.

In one or more embodiments, the target states from different learning processors may conflict. In such case, motor controllers 204 may implement a policy to prioritize, select or blend different target states from the learning processor to generate control signals 246 that operate actuators 222.

FIG. 4 is a conceptual diagram illustrating agents 410A, 410B that respectively include actuators 222A, 222B, according to one embodiment. An agent is a physical or logical construct that may be manipulated to cause changes in sensory input data from one or more associated sensors. The changes in the sensory input data, for example, may be coverage of sensory input data, specificity or fidelity of sensory input data, and/or contents of the sensory input data. Taking the example of tactile sensors, these tactile sensors may be fixed onto a finger of a robotic hand that functions as an agent including an actuator to move the finger. Another example is a camera as the sensor where the camera may be mounted onto a gimbal functioning as an agent including actuators (e.g., motors) in the gimbal. In some examples, the actuators may manipulate objects (or their environment) that are being sensed by the sensors.

Intelligent system 106 may operate with multiple agents associated with different sensors. As shown in FIG. 4, for example, sensors 420A through 420C are associated with agent 410A while sensor 420D is associated with agent 410B. Agent 410A includes actuator 222A that receives control signal 246A from motor controller 204A. Since sensors 420A through 420C are all associated with agent 410A, these sensors may all be manipulated collectively as a set in the same manner by actuator 222A. On the other hand, agent 410B includes actuator 222B that receives control signal 246B from motor controller 204B. Since only sensor 420D is associated with agent 410B, only sensor 420D is manipulated by actuator 222B. In one or more embodiments, a plurality of agents may be organized hierarchically so that an operation of actuators in an agent of a lower hierarchy does not affect another agent at a higher hierarchy while the operation of actuators of an agent at a higher hierarchy affects the agent at a lower hierarchy. Taking an example of a humanoid robot, the movement of a body as a higher agent and the head of the robot as another agent, the movement of the head does not affect changes in the pose of the humanoid robot's body but the movement of the humanoid's body affects changes in the pose of the head.

Motor controllers 204 also generate motor information 216 that enables sensor processors 202 to determine the change in pose of the agent, and thereby the raw poses of sensors associated with the agent. In one embodiment, motor information 216 indicates displacements of actuators relative to a previous time step. In other embodiments, motor information 216 indicates poses (e.g., rotation angles or linear locations) of actuators controlled by motor controllers 204.

Although only a single actuator is illustrated in FIG. 4 as being associated with agent 410A or 410B, more than one actuator may be included in agent 410A or 410B to adjust the poses of agent 410A or 410B with various degrees of freedom. In such case, respective motor controller 204 may generate and send multiple actuators associated with an agent. Further, although only two agents are illustrated in FIG. 4, many more agents may be provided. The sensors associated with the same agent may be of the same modality or different modalities.

### Example Structure of Sensor Processor

FIG. 5 is a block diagram illustrating sensor processor 202 in intelligent system 106, according to one embodiment. Sensor processor 202 generates sensor signal 214 that is suitable for processing by learning processors (e.g., learning processors 206). Sensor processor 202 may also generate reflex signal 312 for directly sending to motor controllers 204 to operate one or more actuators associated with sensors. For these purposes, sensor processor 202 may include, among other components, pose translator 512, feature detector 516, output formatter 520, and reflex module 540.

Pose translator 512 is hardware, software, firmware or a combination thereof for translating a raw pose included in or derived from motor information 216 and feature information 548 into a converted pose 522. Feature information 548 may include information derived from sensory input data 110 to identify the pose of the sensor or the object. For example, feature information 548 may indicate a direction perpendicular to the surface of the object or a principal direction of the curvature. The raw pose may indicate the location and the orientation of an object or a part of the object associated with sensory input data 110 according to a coordinate system local to the sensor or an actuator. Pose translator 512 stores mapping information between the local coordinate system and the common coordinate system. Such mapping information in other sensor processors may be different depending on sensors and/or actuators associated with the sensory input data of the sensor processors. Pose translator 512 combines the mapping information and feature information 548 to generate converted pose 522. Converted poses are expressed in the common coordinate system, and associated learning processors also use various information expressed in the common coordinate system to perform inference, prediction or creation. Converted pose 522 is sent to output formatter 520. Feature detector 516 is hardware, software, firmware or a combination thereof for detecting features in sensory input data 110. Feature detector 516 may store features associated with sensory input data 110 and their corresponding feature identifiers (IDs). When feature detector 516 receives sensory input data 110, it identifies a feature corresponding to sensory input data 110 and generates a corresponding feature ID 526. For example, a sharp edge of an object may be identified as feature 1, a flat surface of the object may be identified as feature 2, etc. Similar features may be pooled into a single feature ID to reduce the number of feature IDs stored and reduce the amount of related resources for processing. If multiple features (e.g., a sharp edge and green color) are detected in sensory input data 110, feature detector 516 may send multiple feature identifiers 526 to output formatter 520.

The unique IDs of the features may be stored in feature detector 516 so that the same feature is identified with the same ID when detected at different times. The same feature may be identified by comparing sensory input data 110 or its part with information on the features, and determining one or more stored features that are similar, based on a method, to sensory input data 110 or its part. In one or more embodiments, the feature ID is assigned so that similar feature IDs are associated with similar features. The similarity of the features and sensory input data 110 or its part may be determined using various methods including, but not limited to, Jaccard index, intersection, Hamming distance, Euclidean distance, and Cosine difference and Mahalanobis distance. The feature IDs may be in a format such as decimals or sparse distributed representations (SDRs). When sending multiple feature identifiers 526, the type of features may also be sent to output formatter 520 (e.g., the first feature represents “color” and is green, and the second feature represents “curvature” and has a value of 0.5).

Output formatter 520 is hardware, software or a combination thereof that generates sensor signals 214 by including converted pose 522 and corresponding feature ID 526. Each of sensor signals 214 may include added noise, which may be Gaussian noise or other types of noise depending on the type of each of sensors associated with sensor processor 202. In one or more embodiments, each of the sensor signals 214 may be entirely or partially encoded into a sparse distributed representation (SDR) format.

Reflex module 540 is hardware, software or a combination thereof for generating reflex signal 312. For this purpose, reflex module 540 receives feature ID 526 and converted pose 522. Reflex module 540 may determine circumstances where prompt actions are to be taken based on the feature ID 526 and the converted pose 522. Such circumstances are associated with, for example, potential failure/damage of the system, risk of injuring people or damage to items in the environment. Reflex module 540 may determine, for example, that the temperature of the object touched by a sensor is above a threshold that may damage or cause a malfunction in the sensor. After detecting potential failure/damage to the system reflex module 540 may generate reflex signals 312 taking into account converted pose 522. For example, reflex module 540 may generate reflex signals 312 that cause motor controllers 204 to operate actuators so that the sensor is moved away from the object quickly, and thereby, avoid any damage to the sensor. In one or more embodiments, reflex signals 312 may override control inputs 240, 244 generated by learning processors.

The structure of sensor processor 202 described in FIG. 5 is merely illustrative. Sensor processor 202 may include additional components or omit one or more components (e.g., reflex module 540). One or more components in sensor processor 202 may also be combined into a single component.

### Example Structure of Learning Processor

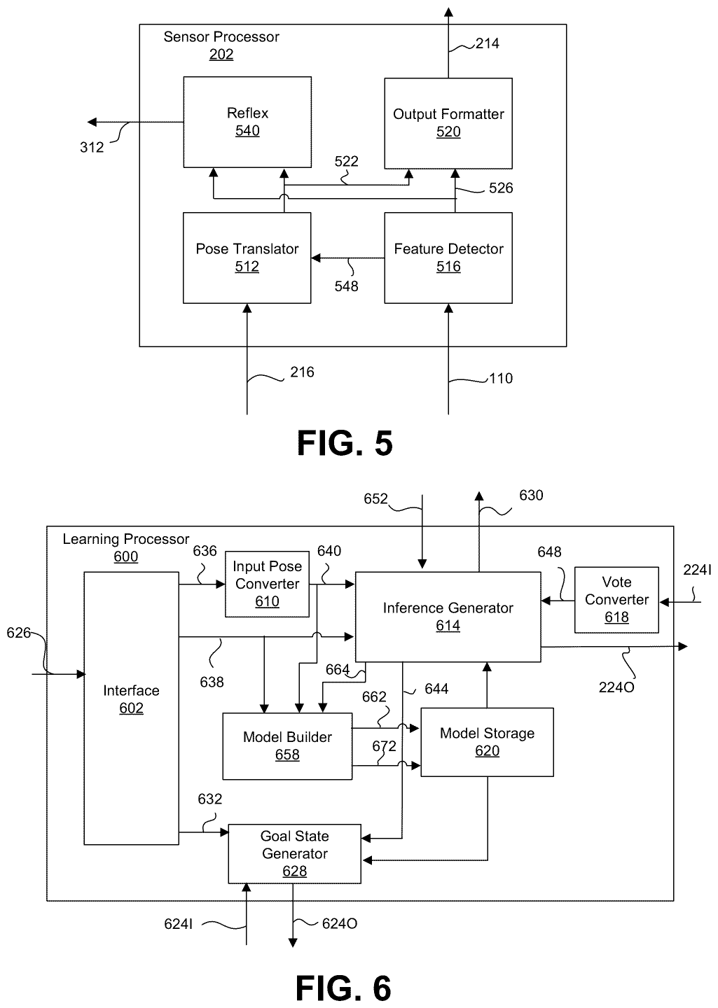

FIG. 6 is a block diagram illustrating learning processor 600 in intelligent system 106, according to one embodiment. Learning processor 600 may be, for example, learning processor 206 or learning processor 210 in FIG. 2. Learning processor 600 receives a sequence of input signal 626 over time, generates a representation of the received sequence of input signal 626, and performs inference, prediction or creation of contents using models it stores. If learning processor 600 determines that input signal 626 does not correspond to any of the models it stores, learning processor 600 may generate a new model and use the new model in subsequent inference, prediction or creation. Such generation of new models may be performed in an unsupervised manner or a supervised manner.

Learning processor 600 may be embodied as software, firmware, hardware or a combination thereof. Learning processor 600 may include, among other components, interface 602, an input pose converter 610, an inference generator 614, a vote converter 618, a model builder 658, a model storage 620 and a goal state generator 628. Learning processor 600 may include other components not illustrated in FIG. 6. Also, some of the components illustrated in FIG. 6 may be combined into a single component. Further, one or more of these components may be embodied as dedicated hardware circuitry.

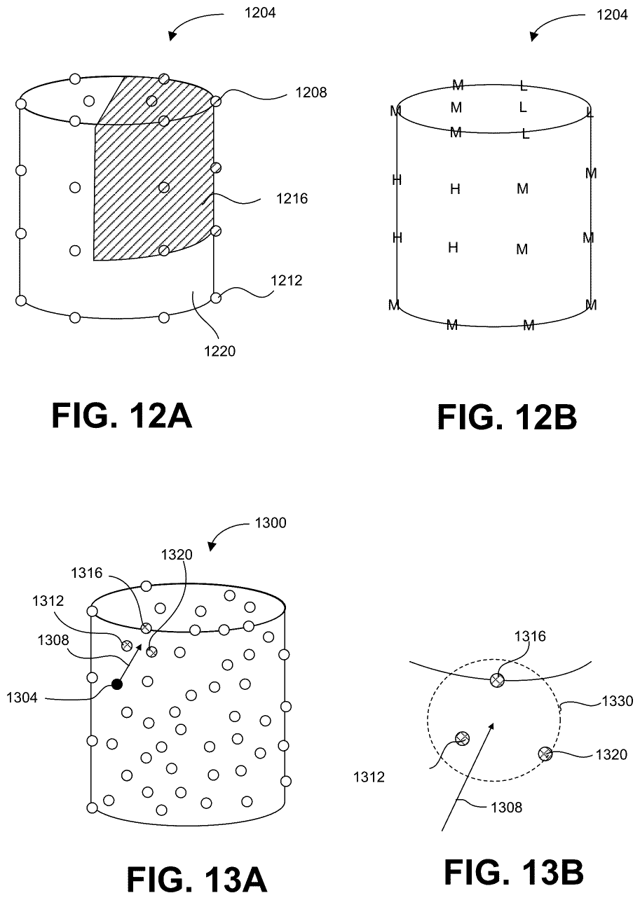

Interface 602 is hardware, software, firmware or a combination thereof for controlling the receipt of input signal 626 and extracting relevant information from input signal 626 for further processing. Input signal 626 may be a sensor signal from a sensor processor, an inference output from another learning processor or a combination thereof. In one or more embodiments, interface 602 stores input signals 626 received within a time period (e.g., a predetermined number of recently received input signals 626), and extracts object information 638 (e.g., detected feature IDs or object IDs) and a current pose 636. Interface 602 may also provide sensory information 632 to goal state generator 628 to assist goal state generator 628 to generate target state 6240. In one or more embodiments, interface 602 may store current poses 636 and object information 638 for a period of time (e.g., an episode cycle as described below in detail with reference to FIG. 14).

Input pose converter 610 is hardware, software, firmware or a combination thereof for determining displacement 640 of current pose 636 of an object or a part/point of the object associated with object information 638 in the current time step relative to a previous pose of the object or the part/point of the object associated with object information 638 in a prior time step. For this purpose, input pose converter 610 includes a buffer to store the previous pose. Alternatively, input pose converter 610 may access interface 602 to retrieve the previous pose.

Model storage 620 stores models of objects and other optional related information (e.g., the configuration of the environment in which the objects are placed). The stored model may be referenced by inference generator 614 to formulate hypotheses on the current object, its pose, its state and/or its environment, and assess the likelihood of these hypotheses. The stored model may be used by the goal state generator 628 to generate the target states. New models may also be generated by model builder 658 for storing in model storage 620.

Inference generator 614 is hardware, software, firmware or a combination thereof for initializing and updating hypotheses on object/objects, their pose/poses and/or their state/states according to object information 638 and displacement 640. For this purpose, inference generator 614 references models stored in model storage 620 and determines which of the models are likely to accurately represent the object based on object information 638 and displacement 640.

Inference generator 614 may also receive further information from other components of intelligent system 106 to make inferences or predictions. For example, inference generator 614 may receive a converted version 648 of lateral vote signal 224I from other learning processors at the same hierarchical level as learning processor 600 via vote converter 618. Inference generator 614 may also receive downstream signal 652 from a learning processor at a higher hierarchical level than that of learning processor 600. Downstream signal 652, for example, corresponds to downstream signal 314 in FIG. 3A. These signals external to learning processor 600 may be used to update the likelihood of the hypotheses or restrict/constrain the hypotheses to be considered. The likelihood may be represented by evidence values corresponding to accumulated evidence or probabilities on the hypotheses.

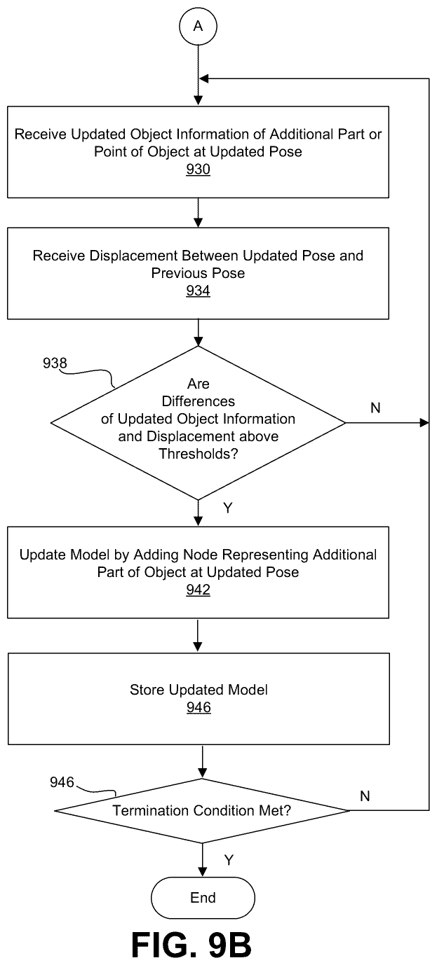

After hypotheses on the objects/environment are formulated using one or more of (i) current poses 636, (ii) object information 638, (iii) converted version 648 of lateral vote signal and (iv) downstream signal, the hypotheses are converted into inference signal 630 and/or lateral vote signal 2240 for sending out to other components of intelligent system 106. The details of generating the hypotheses and updating the hypotheses are described below in detail with reference to FIGS. 10 through 12B.

As part of its operation, inference generator 614 determines whether current poses 636 and object information 638 correspond to models stored in model storage 620. If current poses 636 and object information 638 match those of only one model in model storage 620 and the evidence value associated that model exceeds a threshold, inference generator 614 sends match information 664 to model builder 658 instructing model builder 658 to update the matching model. If more than one model matches current poses 636 and object information 638 received up to that point or the evidence value of the model does not exceed the threshold, match information 664 is not sent to model builder 658. In contrast, if current poses 636 and object information 638 do not match any of the models in model storage 620, inference generator 614 sends match information 664 to model builder 658 instructing model builder 658 to add a new model corresponding to object information 638 and current poses 636.

Inference generator 614 generates inference signal 630 and lateral vote signal 2240 based on its inference or prediction. Inference signal 630 is sent to a learning processor at a higher hierarchical level or to output processor 230 while lateral vote signal 2240 is sent to other learning processors at the same level as learning processor 600 or different levels from that of learning processor 600.

Vote converter 618 is hardware, software, firmware or a combination thereof for converting the coordinates of poses indicated in lateral vote signal 224I into a converted pose that is consistent with the coordinate systems of the models in model storage 620. Each learning processor in intelligent system 106 may generate and store the same model in different poses and/or states. For example, a learning processor may store a model of a mug with a handle of the mug oriented in x-direction while another processor may store the same model with the handle oriented in y-direction. To enable learning processor 600 to account for such differences in stored poses or coordinate system of the models and/or their states, vote converter 618 converts the coordinates of features indicated in lateral vote signal 224I to be consistent with those of the models stored in model storage 620. Additionally, vote converter 618 accounts for spatial offsets of parts of the same object detected by other learning processors that send incoming lateral vote signal 224I. For example, one learning processor may receive sensory information on the handle of a mug, and therefore, generate a hypothesis that its location is on the handle, while another learning processor may receive sensory input from the rim of the same mug. Because of displacements between the features associated with sensor signals fed to different learning processors and resulting differences in hypotheses being generated or updated by different learning processors, vote converter 618 may convert the poses or coordinates as indicated in lateral vote signal 2241 in a different manner for each model and/or its state.

Although not illustrated in FIG. 6, a downstream converter may also be provided in learning processor 600 to convert downstream signal 652 from an upper-level learning processor so that any object information in downstream signal 652 is represented in the same pose and/or coordinate system as the models stored in model storage 620.

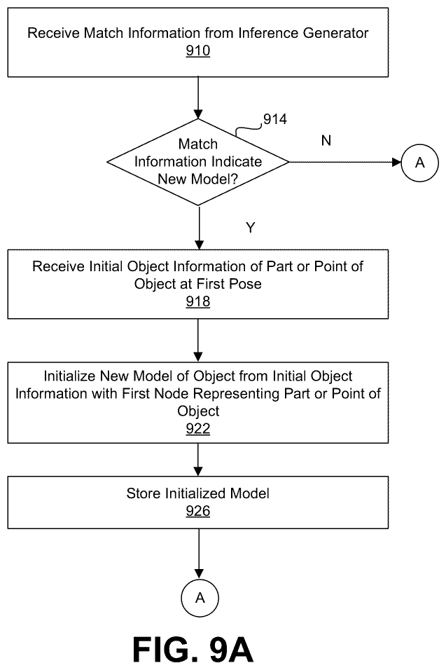

Model builder 658 is hardware, software or a combination thereof for generating models or updating models. After model builder 658 receives match information 664 from inference generator 614, model builder 658 may generate new model 662 and store it in model storage 620 or update a model stored in model storage 620. Match information 664 indicates whether a sequence of input signals 626 is likely to match a model stored in model storage 620 and the likely pose of the object. The details of the process for generating or updating models are described below in detail with reference to FIGS. 9A and 9B. If model builder 658 determines that information of a model stored in model storage 620 is to be updated, model builder 658 sends update information 672 to model storage 620 to update the model.

Goal state generator 628 is hardware, software, firmware or a combination thereof for determining target states of agents, when executed by actuators, would resolve ambiguities associated with the prediction/inference, and thereby, enable more accurate determination of the current object or detect different aspects of a new model to better learn the new object. The goal state generator 628 may also be used beyond learning, prediction and inference. For instance, the target state 6240 of goal state generator 628 may be used to manipulate objects, place the environment in a certain state, communicate or generate content. For these purposes, goal state generator 628 receives match information 644 from inference generator 614 and sensory information 632 from interface 602. Match information 644 indicates a list of models or their states that are likely to correspond to the current sensations included in input signal 626. Goal state generator 628 executes a set of logic embodying a policy to generate target state 6240 of the agents that is likely to resolve or reduce any ambiguity or uncertainty associated with multiple candidate objects or detect new features in the new object being learned. For example, if inference generator 614 determines that the current object is either a sphere or a cylinder, goal state generator 628 may determine the target state of an agent associated with a tactile sensor to be placed at either an upper end or lower end of the current object. Depending on whether a rim is detected, the current object may be determined to be a sphere or a cylinder.

To generate its target state 6240, goal state generator 628 may also receive incoming target state 624I from other components of intelligent system 106 and sensory information 632 from interface 602. Sensory information 632 may indicate, among others, (i) the success/failure of prior attempts of target states, and (ii) previous poses. Goal state generator 628 may take into account sensory information 632 so that a target state covers previously unsuccessful target states while avoiding a target state that may be redundant due to prior poses. Goal state generator 628 may also consider the incoming target state 624I and sensory information 632 to generate target state 6240. In one or more embodiments, incoming target state 624I indicates a higher-level target state generated by another learning processor (e.g., a learning processor at a higher hierarchical level). The higher-level target indicated in target state 624I may be decomposed into target state 6240 indicative of a lower-level target state relevant to learning processor 600. In this way, goal state generator 628 may generate target state 6240 which is in line with the higher-level target state. Further, target state 624I may be received from learning processors in the same hierarchical level or a lower hierarchical level so that conflicts with target states of other learning processors may be reduced or be avoided. In this way, the overall accuracy and efficiency of intelligent system 106 may be improved. Target state 6240 may be sent as control inputs 240, 242 to motor controllers 204.

The components of learning processor 600 and their arrangement in FIG. 6 are merely illustrative. Intelligent system 106 may use learning processors of different architectures and operating algorithms adapted to sensory input data 110 or its application.

### Example Structure of Model Builder

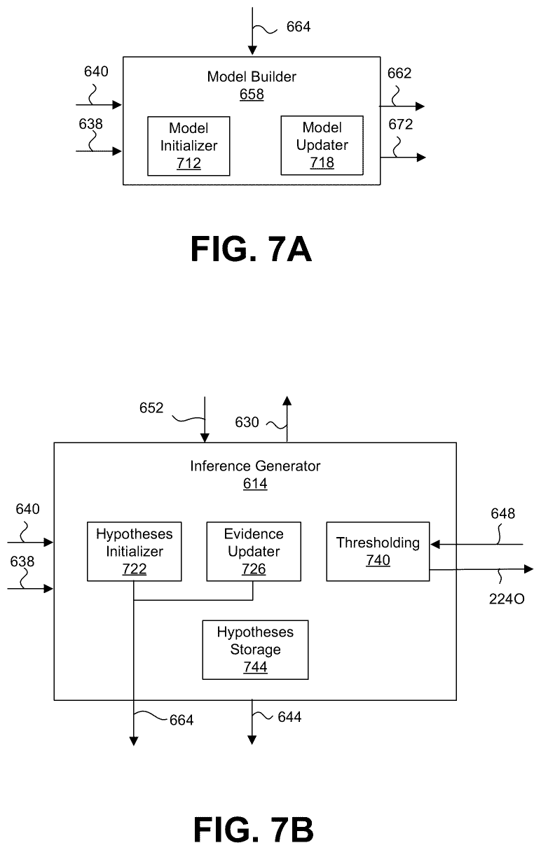

FIG. 7A is a block diagram illustrating model builder 658 in learning processor 600, according to one embodiment. Model builder 658 may include, among other components, model initializer 712 and model updater 718. When match information 664 indicates that a new model is detected, model initializer 712 is activated to generate new model 662 for storing in model storage 620. In contrast, model updater 718 is activated to update a corresponding model stored in model storage 620 with additional information (e.g., new nodes and associated features) by sending update information 672 to the model storage 620 when match information 664 received from inference generator 614 indicates that the candidates of the hypothesis is consistent with one or more models stored in model storage 620.

New model 662 or each model stored in model storage 620 may be a graph model. Referring to FIG. 10, a graph model representing a mug is illustrated. The graph model includes nodes 1002 and edges 1006 connecting the nodes 1002. Each of the nodes has a pose and may be associated with one or more features. Taking the example of FIG. 10, each node includes the feature of normal vector 1010 indicating a direction of normal vector at a surface point of a model representing a mug and the feature of curvature direction 1014 indicating the direction of a principal curvature at the same surface point. Depending on applications and objects, various other features may be used instead or in addition. For example, colors at different surface points may be used as an alternative or additional feature.

Other types of models may be used instead or in addition to graph models. The other types of models include, among others, recurrent neural networks (RNN), spiking neural networks (SNN), hierarchical temporal memory (HTM), transformers and other machine learning techniques. In some embodiments, a model of an object may be represented using a single type of model while other multiple models of different types may be used to represent a single object. Further, a single model may be used to represent multiple objects.

Model builder 658 also assigns a unique object identifier (ID) to a new model it generates. Different learning processors in intelligent system 106 may assign different object IDs to the same object. Further, some learning processors may assign different object IDs to different states of an object whereas other learning processors may assign the same object ID to the same object in different states. To address such differences in object IDs across different learning processors, vote converter 618 may further store relationships between object IDs of learning processor 600 and object IDs of other learning processors. Using such stored relationships, vote converter 618 may convert the object IDs in lateral vote signal 224I to match object IDs of models stored in model storage 620. One of many ways of generating the relationships between object IDs in different learning processors is to identify models that are determined to be most likely by different learning processors during the same or similar time frame, and establish a relationship that object IDs of these models represent the same object. For example, if each of the different learning processors generated their respective object IDs at the same time or within a predetermined time frame, these object IDs may be determined as corresponding to the same object, and therefore, store mapping of these object IDs as indicating the same object.

### Example Structure of Inference Generator

FIG. 7B is a block diagram illustrating inference generator 614 in learning processor 600, according to one embodiment. Inference generator 614 may include, among other components, hypotheses initializer 722, evidence updater 726, thresholding module 740 and hypotheses storage 744. Inference generator 614 may include components not illustrated in FIG. 7B. Further, some of the components in FIG. 7B may be combined into a single component.

Hypotheses initializer 722 generates a list of candidate models and poses corresponding to initial object information (e.g., feature) received from interface 602. Initial object information refers to the first object information 638 received for a current object. Hypotheses initializer 722 assigns an evidence value for each model according to the likelihood that initial object information 638 is associated with an object, its pose and/or its state corresponding to each model. When hypotheses initializer 722 does not detect any models that are likely to correspond to the current object based on initial object information 638, then hypotheses initializer 722 may send match information 664 to model builder 658 indicating that a new model is to be generated. In some embodiments, match information 664 indicating the generation of a new model is sent after a threshold amount of object information is accumulated to indicate that no model stored in model storage 620 matches the accumulated object information. In one or more embodiments, hypothesis initializer 722 uses regularities of objects and/or their circumstances to generate the list of candidate models and poses. For example, the regularities associated with a mug may indicate that it is generally placed with the flat bottom resting on a floor. Such regularities may be leveraged to make the inference more efficient and robust.

Evidence updater 726 uses the subsequent object information 638 and its displacement 640 to update evidence values associated with candidate models. In one or more embodiments, upon receiving object information 638, evidence updater 726 searches for a matching point or part of each candidate model corresponding to the displacement relative to a previous pose. The search may be performed within a search region of the candidate model around the point or part of the model indicated by the displacement 640 from the previous pose. The search region may be determined by heuristics or other factors such as the surface characteristics of the object corresponding to the candidate model. If evidence updater 726 determines that there is no candidate model likely to correspond to the current object based on subsequent object information 638 and displacement 640, then evidence updater 726 sends match information 664 to model builder 658 indicating that a new model is to be generated. Evidence updater 726 may also update evidence values according to converted version 648 of incoming lateral vote signals and/or downstream signal 652. For example, evidence updater 726 may increase the evidence values of models that are consistent with converted version 648 of incoming lateral vote signal and downstream signal 652.

In one or more embodiments, the features of objects (e.g., object information 638) are used for increasing the evidence values but not for decreasing the evidence values. In contrast, when there is no surface or part of the model at the location indicated by displacement 640, then the evidence value for that model is decreased. In some embodiments, a higher evidence value of a hypothesis indicates a higher likelihood that the hypothesis is correct. In other embodiments, the lower evidence value may indicate a higher likelihood. Evidence updater 726 may also normalize the evidence values within a range (e.g., a range from 0 to 1) after updating their values.

Thresholding module 740 performs various thresholding operations to increase the efficiency of operations associated with inference, prediction or creation at learning processor 600. Thresholding module 740 may parse through converted version 648 of incoming lateral vote and remove or filter out certain models, poses or states and their evidence values in the incoming lateral vote if the evidence values of these models, poses or states are below a threshold. Further, thresholding module 740 may perform a management operation to mask or zero out any evidence values in hypotheses storage 744 that are below a threshold. By pruning models or hypotheses, processing associated with models or hypotheses of low evidence values may be obviated, and thereby increasing the overall efficiency of inference generator 614.

Hypotheses storage 744 is non-transitory memory storing models and their object IDs. The models may represent various objects and/or their potential poses and states. In some embodiments, all objects in various poses and states of a model may be stored as the same model in hypotheses storage 744, while in other embodiments, different models may be generated and stored for the same object with different poses and/or states.

### Method of Operating Intelligent System

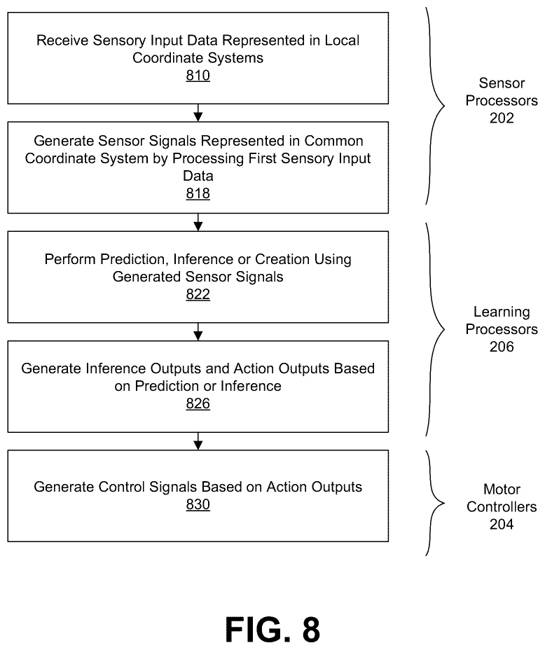

FIG. 8 is a flowchart illustrating overall processes in the intelligent system, according to one embodiment. Sensor processors 202 receive 810 sensory input data represented in local coordinate systems. Each of the local coordinate systems is local to a sensor that generates the corresponding sensory input data. Sensor processor 202 stores mapping between the local coordinates and the common coordinate systems.

In response to receiving the sensory input data, sensor processors 202 generate 818 sensor signals, each including a converted pose in a common coordinate system and one or more feature IDs. The converted pose includes, for example, the location and the orientation of an object or a part of the object expressed in the common coordinate system.

Learning processors 206 receive the sensor signals and perform 822 prediction, inference or creation based on the generated sensor signals. As a result, the learning processors 206 generate 826 inference outputs sent to one or more other learning processors or an output processor. The inference output sent to the output processor may be used for generating a system output. The learning processor also generates 826 an action output based on the prediction, inference or creation. The learning processors may also generate lateral voting signals sent to other learning processors at their same level or different levels.

Motor controllers receive the action outputs generated by the learning processors. In response, these motor controllers generate 830 control signals for operating actuators.

The processes and their sequence described above with reference to FIG. 8 are merely illustrative. For example, the processes may be performed in a partially parallel fashion where the process of generating 818 the sensor signals is performed asynchronously across different sensors and the sensor processors. Some sensor signals may be generated ahead of other sensor signals, and may be sent to corresponding learning processors that may perform prediction, inference or creation while other learning processors await their sensor signals or only receive top-down feedback or lateral voting signals.

### Example Process at Model Builder

FIGS. 9A and 9B are flowcharts illustrating a process of generating or updating models by model builder 658, according to one embodiment. Model builder 658 receives 910 match information 664 from inference generator 614 indicating whether a new model is to be generated or a model stored in model storage 620 is to be updated.

It is determined 914 whether match information 664 indicates that a new model is to be generated, initial object information 638 of part or point of a current model at a first pose is received 918. A model of the current object is initialized 922 using the first object information by adding a first node representing the first part or point of the current object. The initialized model is then stored 926 in model builder 658 or model storage 620. Then the process proceeds to receiving 930 updated object information and subsequent processes illustrated in FIG. 9B.

If it is determined 914 whether match information 664 indicates that a model is detected from models stored in model storage 620 or a new model has been initialized, then model builder 658 receives 930 updated object information of an additional part or point of the current object at an updated pose. Model builder 658 further receives 934 a displacement between the updated pose and the first pose.

It is then determined if the difference between new object information and existing object information is above thresholds. If not, the updated object information and the location/rotation differences represented by the displacement are determined to be redundant and the process returns to receiving 930 subsequently updated object information.

If the differences are above the thresholds, then the model is updated 942 by adding a new node representing an additional part or point of the object at the updated pose. The updated model with the new node is then stored in model builder 658 or model storage 620.

Then it is determined 946 whether a termination condition for updating the model is met. The termination condition may include exhausting all the sets of object information 638 and displacement 640 associated with the model available in a current cycle and filling up the capacity of the buffer in interface 602. If there are further object information 638 and displacement 640 for updating the model that were not reflected in the current cycle, the process of receiving 930 updated object information and subsequent processes may be repeated in the next cycle to update the model according to the additional object information 638 and displacements 640.

If the termination condition is not met, the process returns to receiving 930 updated object information. If the termination condition is met, then the process at model builder 658 is concluded and the updated model (if temporarily stored in model builder 658) is transferred to model storage 620.

The steps and sequence of steps of FIGS. 9A and 9B are merely illustrative. Some steps may be omitted or modifications to the sequence may be made. For example, the step of determining 938 the differences may be omitted. Further, receiving 930 of updated object information and receiving 934 of displacement may be performed in parallel or in a reverse order.

### Example Process at Inference Generator

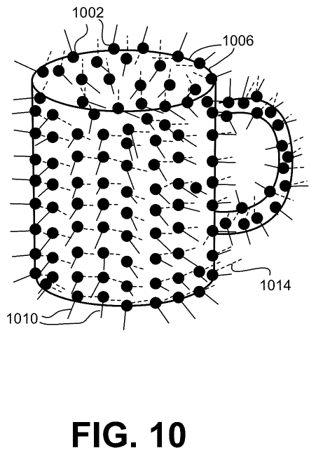

FIGS. 11A and 11B are flowcharts illustrating operations at inference generator 614, according to one embodiment. Initial object information 638 is received 1110 by inference generator 614. Based on the received initial object information 638, hypotheses of models corresponding to objects, their poses and/or states are initialized 1116. Specifically, models that are inconsistent with the initial object information 638 are assigned with a low evidence value while models that are consistent with the initial object information 638 are assigned a high evidence value. Different hypotheses are generated in which different nodes of the models are assumed to correspond to a point or part of the current object that is associated with initial object information 638.

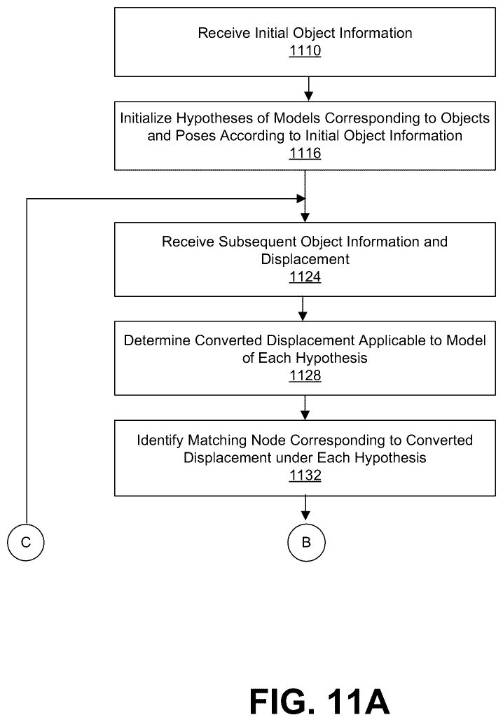

Referring to FIG. 12A, model 1204 of a cylindrical object has portion 1216 that has a blue color and portion 1220 that has a red color. Model 1204 includes nodes (e.g., nodes 1208, 1212) represented by circles. A blank node (e.g., node 1212) is associated with the feature of color red and the feature of curvature information (e.g., flat, curved or edge). A hatched node (e.g., node 1208) is associated with the feature of blue color and the feature of curvature information.

When initial object information indicating features of red color and a curved surface is received, inference generator 614 assigns an evidence value to each node according to the matching of the features, as shown in FIG. 12B, to indicate the likelihood that the node corresponds to a point or part on the current model associated with the initial object information. In FIG. 12B, “H” indicates assigning of a high evidence value, “L” indicates assigning of a low evidence value, and “M” indicates assigning of a medium evidence value. Such operations are repeated for different hypotheses of different models, different initial poses, and/or states of the same model.

Referring back to FIG. 11A, subsequent object information 638 and displacement 640 are then received 1124. Displacement 640 is determined by input pose converter 610 based on current pose 636 and a prior pose stored in input pose converter 610.

Then, a converted displacement applicable to a model of each hypothesis is determined 1128. Displacement 640 derived from input signal 626 may not match the pose and orientation of the model stored in model storage 620. Hence, displacement 640 is rotated into converted displacement so that the node of the model at the converted displacement relative to the initial pose corresponds to displacement 640 on the current object.

Based on the converted displacement, inference generator 614 identifies 1132 a matching node on each of the models corresponding to the converted displacement of each hypothesis. Each model may include nodes (or points) that are discretized at a high granularity. Further, object information 638 and displacement 640 may include noise due to inaccurate sensing and various post-processing operations. For these reasons, a node of the model at the location closest to the end of the converted displacement may not necessarily correspond to a point or part of the object. Hence, inference generator 614 may select one of the multiple nodes within a search area of the model around the converted displacement and use the selected point to compare with object information 638, displacement 640 or both. In this way, the comparison or matching of the current object and models may be performed more robustly despite discretization and noise in input signal 626 and does not require sampling the same points as done during training.

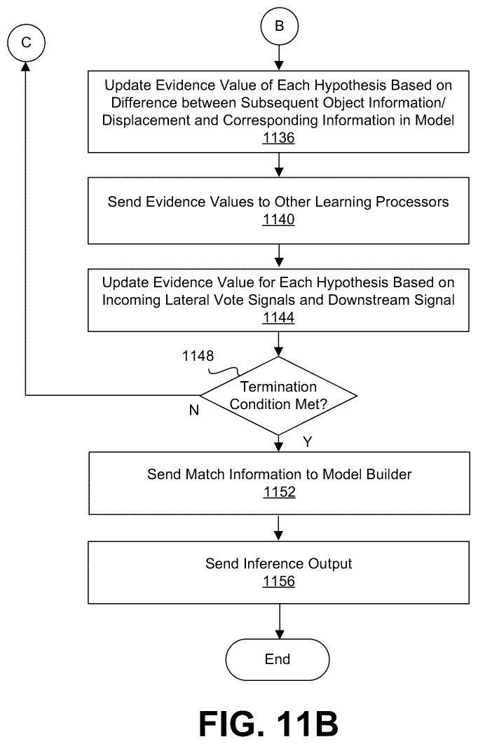

FIGS. 13A and 13B illustrate a hypothesis where node 1304 of model 1300 is assumed to correspond to a part of the current object associated with a prior (or initial) object information. A converted displacement of a subsequent object information is indicated by arrow 1308. Search area 1330 to conduct a search for selecting a node of the model associated with the subsequent object information is set around the end point of arrow 1308. As shown in FIG. 13B, three nodes 1312, 1316, 1320 are located within search area 1330. In one embodiment, one node having the best matching features and pose is selected among these three nodes 1312, 1316, 1320 and its similarity to the observed feature is used for updating the evidence value of the current hypothesis. The process of generating the converted displacement and searching for a matching node are repeated for different hypotheses. Each node in FIG. 13A may correspond to one or more hypotheses.

Inference generator 614 generates multiple hypotheses where each hypothesis indicates a combination of (i) a certain model corresponding to the current object, (ii) a certain node in the model corresponding to prior (or initial) object information, and (iii) the direction in which a converted displacement is to be rotated.

Referring back to FIG. 11B, the evidence value of each hypothesis is then updated 1136 according to, among other factors, (i) the difference between the object information 638 and the features of the matching node, and (ii) the difference between the pose of the part or point of the current object associated with object information 638 and the pose of the matching node according to the hypothesis. If the differences are smaller, the evidence values are increased by a larger amount whereas if the differences are larger, the evidence values are increased by a smaller amount, decreased or maintained. Different weights may be given to each difference when determining the amount to be added or subtracted from the evidence value. In one or more embodiments, only evidence values above a threshold are updated while the remaining evidence values remain unchanged to reduce computing. The process of updating the evidence values is repeated for different hypotheses.

The updated evidence values and related information (e.g., ID) are then sent 1140 to other learning processors as outgoing lateral vote signal 2240. Thresholding may be performed on the updated evidence values so that only the updated evidence values with absolute values above a level or the updated evidence values that are changed above a level are sent out as outgoing lateral vote signal 2240 while the remaining updated evidence values are not sent out in the outgoing lateral vote signal 2240. The other learning processors may perform inference, prediction or creation using the lateral vote signal 2240 in the same manner as learning processor 600.

Incoming lateral vote signals 224I and downstream signal 652 are received from other learning processors. These signals are then used by inference generator 614 to update 1144 the evidence value of each hypothesis. Specifically, the evidence values for hypotheses that are consistent with lateral vote signal 2241 and downstream signal 652 may be increased while the evidence values of hypotheses that are inconsistent with these signals are reduced or maintained.

Then it is determined 1148 whether a termination condition is met. The termination condition may include, but is not limited to, exhausting all the sets of object information and the displacement available in the current cycle, filing up of the buffer in interface 602, identifying of a matching model with an evidence value above a threshold, failure to detect any models matching the detected features and the displacements, reaching of a set time limit or cycles and reaching of the termination condition by a set number or percentage of other learning processors. If the termination condition is not met, then the process returns to receiving 1124 of the subsequent object information and the displacement. In one or more embodiments, thresholding of the updated evidence values in hypotheses storage 744 may be performed before returning to receiving 1124 the subsequent object information and the displacement to increase the efficiency of subsequent processing.

If the termination condition is met, then the match information is sent 1152 to model builder 658 so that a model stored in model storage 620 may be updated or a new model may be generated. If the evidence values for none of the stored models exceed a threshold, then the sending of match information may be omitted. Further, inference signal 630 is generated and sent to other learning processors or output processor 230.

The processes of FIGS. 11A and 11B are merely illustrative. Some of the processes may be omitted or the sequence of the processes may be modified. For example, updating evidence value for each hypothesis based on lateral vote signals and the downstream signal may be omitted. Further, the sending of match information and the sending of inference output may be performed in parallel or in a reverse order.

### Performing Inference/Prediction and Model Building/Updating

In one or more embodiments, learning processor 600 operates in units of episode cycles. FIG. 14 is a conceptual diagram illustrating the operation of learning processor 600 in two different episode cycles, according to one embodiment. Each episode cycle (e.g., EP1, EP2) includes a pair of an inference/prediction cycle performed by inference generator 614 and a subsequent model building/updating cycle performed by model builder 658. During the inference/prediction cycle, inference generator 614 performs the operations described above with reference to FIGS. 11A and 11B. During the model building/updating cycle, model builder 658 performs the operations described above with reference to FIGS. 9A and 9B.

After the current episode (e.g., EP1) is finished, a next episode (e.g., EP2) including its inference/prediction cycle may be performed by inference generator 614 using a next set of current poses 636 and object information 638 followed by a model building/updating cycle using the same set of current poses 636 and object information 638 by model builder 658. In an episode cycle, interface 602 buffers all current poses 636 and object information 638. Current poses 636 and 638 received in the episode cycle may first be streamed to inference generator 614. After inference generator 614 provides match information 664 to model builder 658, the poses 636 and object information 638 buffered in interface 602 may be provided again to model builder 658 for updating a model or generating a new model.

By operating learning processor 600 in units of episode cycles, the adding of a new model or updating of the stored model may be performed more efficiently since inference generator 614 may make a more accurate determination on whether object information 638 and current poses 636 match a model stored in model storage 620, and direct model builder 658 to perform subsequent operations according to the determination.

### ALTERNATIVE EMBODIMENTS

Although above embodiments are described primarily with respect to performing inference or prediction, the same principle may be applied to the creation of contents by the inference processors. In such cases, the inference processors generate and output created contents based on models that they store instead of performing object recognition. Specifically, based on the inference or prediction performed by inference generator 614, goal state generator 628 generates target state 6240 that corresponds to created contents.

### Example Computing Device for Implementing Intelligent System

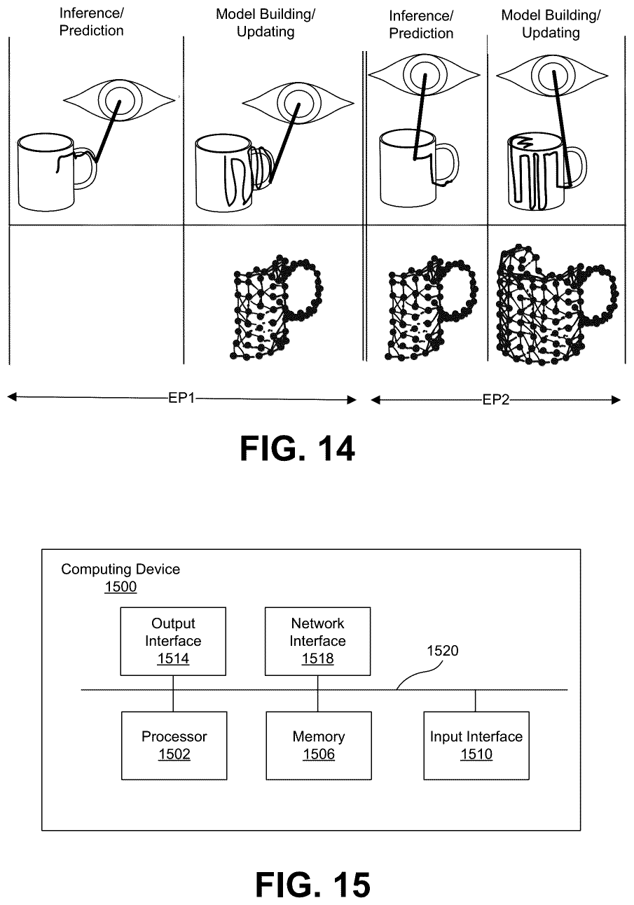

FIG. 15 is a block diagram of a computing device 1500 for implementing intelligent systems, according to embodiments. The computing device 1500 may include, among other components, a processor 1502, a memory 1506, an input interface 1510, an output interface 1514, a network interface 1518, and a bus 1520 connecting these components. The processor 1502 retrieves and executes commands stored in memory 1506. The memory 1506 stores software components including, for example, operating systems and modules for instantiating and executing nodes as described herein. The input interface 1510 receives data from external sources such as sensor data or action information. The output interface 1514 is a component for providing the result of computation in various forms (e.g., image or audio signals). The network interface 1518 enables the computing device 700 to communicate with other computing devices by a network.

While particular embodiments and applications have been illustrated and described, it is to be understood that the invention is not limited to the precise construction and components disclosed herein and that various modifications, changes and variations may be made in the arrangement, operation and details of the method and apparatus disclosed herein without departing from the spirit and scope of the present disclosure.

What is claimed is:

1. A computer-implemented method comprising:
receiving one or more features of an object;
receiving, by a first learning processor, a current pose associated with the one or more features of the object;
converting the current pose to a displacement relative to a previous pose received prior to the current pose;
responsive to determining that the one or more features and the displacement match one or more models, updating evidence values of the one or more models; and
responsive to determining that the one or more features and the displacement do not match the models, generating a new model corresponding to the displacement and associated with the one or more features.

2. The method of claim 1, wherein each of the models indicates one more of a candidate identity of the object, a candidate pose of the object or a candidate state of the object.

3. The method of claim 1, further comprising storing the new model in the first learning processor responsive to generating the new model.

4. The method of claim 1, further comprising wherein generating of the new model is performed in an unsupervised manner.

5. The method of claim 1, wherein each of the models is a graph model including a plurality of nodes corresponding to different parts of a candidate object, each of the nodes associated with one or more features.

6. The method of claim 1, further comprising:
obtaining converted displacements that coincide with poses of the one or more models by rotating the displacement; and
using the converted displacement to determine locations of the models for comparing with the one or more features associated with the object.

7. The method of claim 1, wherein updating the evidence values comprises:
receiving, by the first learning processor, a lateral vote signal indicating one or more of (i) a candidate identity of the object, (ii) a candidate pose of the object, or (iii) a candidate state of the object, as predicted by a second learning processor at a same hierarchical level as the first learning processor; and
adjusting the evidence values according to the lateral vote signal.

8. The method of claim 7, wherein updating the evidence values further comprises:
receiving, by the first learning processor, a downstream signal indicating (i) a candidate identity of the object, (ii) a candidate pose of the object, or (iii) a candidate state of the object, as predicted by a third learning processor at a hierarchical level higher than the first learning processor; and
adjusting the evidence values according to the downstream signal.

9. The method of claim 7, further comprising:
receiving, by a first sensor processor, first sensory input data;
identifying, by the first sensor processor, the one or more features by processing the first sensory input data;
receiving, by the first sensor processor, a first raw pose associated with the first sensory input data, the first pose represented in a first local coordinate system;
processing the first raw pose into a first converted pose represented in a common coordinate system; and
sending the one or more features and the first converted pose from the first sensor processor to the first learning processor.

10. The method of claim 9, further comprising:
receiving, by a second sensor processor, second sensory input data;
identifying, by the second sensor processor, one or more additional features by processing the second sensory input data;
receiving, by the second sensor processor, a second raw pose associated with the second sensory input data, the first pose represented in a second local coordinate system different from the first local coordinate system;
processing the second raw pose into a second converted pose represented in the common coordinate system; and
sending the one or more additional features and the second converted pose from the second sensor processor to the second learning processor.

11. The method of claim 7, further comprising:
receiving a sensor signal by the second learning processor, the sensor signal indicating one or more additional features of the object and an additional pose;
determining one or more of the candidate poses and candidate identities of the object associated with the sensor signal by comparing with models stored in the second learning processor; and
generating the lateral vote signal based on the comparing with the models stored in the second learning processor.

12. The method of claim 1, further comprising:
generating, by the first learning processor, an action output to a motor controller to cause one or more actuators to transition to a target pose of the one or more actuators, the one or more actuators associated with a sensor for detecting the one or more features.

13. A non-transitory computer readable storage medium storing instructions thereon, the instructions when executed by one or more processors cause the one more processors to:
receive one or more features of an object;
receive a current pose associated with the one or more features of the object;
convert the current pose to a displacement relative to a previous pose received prior to the current pose;
responsive to determining that the one or more features and the displacement match one or more stored models, update evidence values of the one or more stored models; and
responsive to determining that the one or more features and the displacement do not match the stored models, generate a new model corresponding to the displacement and associated with the one or more features.

14. The non-transitory computer readable storage medium of claim 13, wherein each of the stored models indicates one more of a candidate identity of the object, a candidate pose of the object or a candidate state of the object.

15. The non-transitory computer readable storage medium of claim 13, wherein the instructions further cause the one or more processors to store the new model responsive to generating the new model.

16. The non-transitory computer readable storage medium of claim 13, further comprising generating of the new model is performed in an unsupervised manner.

17. The non-transitory computer readable storage medium of claim 13, wherein each of the stored models is a graph model including a plurality of nodes corresponding to different parts of a candidate object, each of the nodes associated with one or more features.

18. The non-transitory computer readable storage medium of claim 13, wherein the instructions further cause the one or more processors to:
obtain converted displacements that coincide with poses of the one or more models by rotating the displacement; and
use the converted displacement to determine locations of the stored models for comparing with the one or more features associated with the object.

19. The non-transitory computer readable storage medium of claim 13, wherein the instructions further causing:
a first processor of the one or more processors to receive a signal indicating one or more of (i) a candidate identity of the object, (ii) a candidate pose of the object, or (iii) a candidate state of the object, as predicted by a second processor of the one or more processors; and
adjust the evidence values by the first processor according to the received signal.

20. A computing device comprising:
a first learning processor configured to:
receive one or more features of an object,
receive a current pose associated with the one or more features of the object;
convert the current pose to a displacement relative to a previous pose received prior to the current pose,
responsive to determining that the one or more features and the displacement match one or more first models stored in the first learning processor, update evidence values of the one or more stored models, and
responsive to determining that the one or more features and the displacement do not match the first models, generate a new model corresponding to the displacement and associated with the one or more features; and
a second learning processor configured to:
receive one or more additional features of the object and an additional pose, determine one or more of candidate poses or candidate identities of the object by comparing the one or more features and the additional pose with second models stored in the second learning processor,
generate a lateral vote signal based on the comparing with the models stored in the second learning processor, and
send the lateral vote signal to the first learning processor to adjust the evidence values or generate the new model.
